(19) United States
(12) Patent Application Publication
(10) Pub. No.: US 2007/0205334 A1
(43) Pub. Date: Sep. 6, 2007

(54) OFFICE WORK APPARATUS FOR CARS

(76) Inventor: BOYEAN KIM, SEOUL (KR)

Correspondence Address: IPLA P.A., 3580 WILSHIRE BLVD., 17TH FLOOR, LOS ANGELES, CA, 90010, US

(21) Appl. No.: 11/747,712

(22) Filed: May 11, 2007

Related U.S. Application Data
(62) Division of application No. 10/435,519, filed on May 9, 2003, now Pat. No. 7,236,355.

(51) Int. Cl. G12B 9/00

(52) U.S. Cl. 248/27.1

(57) ABSTRACT

An office work apparatus for cars comprising, an information treatment equipment includes a keyboard and a display, a frame to which the information treatment equipment is detachably mounted, and an on-wheel mounting member for detachably installing the information treatment equipment on a steering wheel of a vehicle. A user for the office work apparatus can access Internet and handle his or her business in a driver's seat. Also, the office work apparatus is placed on the steering wheel for handling the user's work, the office work apparatus with the keyboard is safely mounted on the groove with a buffer spring, such that the office work apparatus can be protected from the impacts applied from the outside, without any shaking.

### CROSS REFERENCE

This is a divisional application of patent application Ser. No. 10/435,519 filed May 9, 2003, which claims priority of International Application No. PCT/KR02/00011 filed Jan. 4, 2001.

### FIELD OF THE INVENTION

The present invention relates to a user-friendly office work apparatus for cars.

### BACKGROUND OF THE INVENTION

Various types of the office work apparatus are well known. However, the office work apparatus to use conveniently at a driver's seat inside a car is not developed.

### SUMMARY OF THE INVENTION

It is an object of the present invention to provide an office work apparatus that enables a user to handle his or her work in a car and is mounted in an attachable and detachable manner.

In order to achieve this object of the present invention, there is provided an office work apparatus for cars comprising, information treatment equipment includes a keyboard and a display, a frame to which the information treatment equipment is detachably mounted, and an on-wheel mounting member for detachably installing the information treatment equipment on a steering wheel of a vehicle.

### BRIEF DESCRIPTION OF THE DRAWINGS

The above and other objects and features of the present invention will become apparent from the following description of preferred embodiments given in conjunction with the accompanying drawings, in which:

FIG. 1 shows an exemplary view of the whole construction of office work apparatus according to the present invention;

FIG. 2 shows an example for the office work apparatus in use in FIG. 1;

FIG. 3a shows a view for the foldable parts among the office work apparatus in FIG. 1;

FIG. 3b shows another embodiment of the grip in FIG. 2;

FIG. 4 shows another example for the office work apparatus in use in FIG. 1;

FIG. 5 shows the coupling of the shaft into the frame in FIG. 1;

FIG. 6 shows another embodiment of FIG. 5;

FIG. 7 shows still another embodiment of FIGS. 5 and 6;

FIG. 8 shows a perspective view for the office work apparatus according to the present invention;

FIG. 9 shows an exploded view for the office work apparatus according to the present invention;

FIG. 10 shows a schematic view for the rotating state of the office work apparatus according to the present invention;

FIG. 11 shows an exploded view for another structure of the office work apparatus according to the present invention;

FIG. 12 shows a perspective view for the coupled state of the office work apparatus according to the present invention;

FIG. 13 shows a perspective view for the separated state of the office work apparatus according to the present invention;

FIG. 14 shows a view for the office work apparatus according to the present invention;

FIG. 15 shows a view for the frame mounted in the office work apparatus according to the present invention; and

FIG. 16 shows a bottom view for the frame mounted in the office work apparatus according to the present invention.

FIG. 17 shows still another embodiment of the present invention.

FIG. 18 shows still another embodiment of the present invention.

FIG. 19 shows still another embodiment of the present invention including a frame body having a modified configuration.

FIG. 20 shows still another embodiment of the present invention including a carrying member for mounting the office work apparatus.

FIG. 21 shows still another embodiment of the present invention including a locking member for fixing the office work apparatus to the frame body.

FIG. 22 shows still another embodiment of the present invention including an engaging member having a modified configuration.

FIG. 23 shows still another embodiment of the present invention including an engaging member having a modified configuration.

FIG. 24 shows still another embodiment of the present invention including an engaging member having a modified configuration.

FIG. 25 shows still another embodiment of the present invention including a frame body having a supporting plate.

FIG. 26 shows still another embodiment of the present invention including a carrying member having a modified configuration.

### DETAILED DESCRIPTION OF THE PREFERRED EMBODIMENTS

Now, an explanation of the preferred embodiments of the present invention will be described with reference to accompanying drawings.

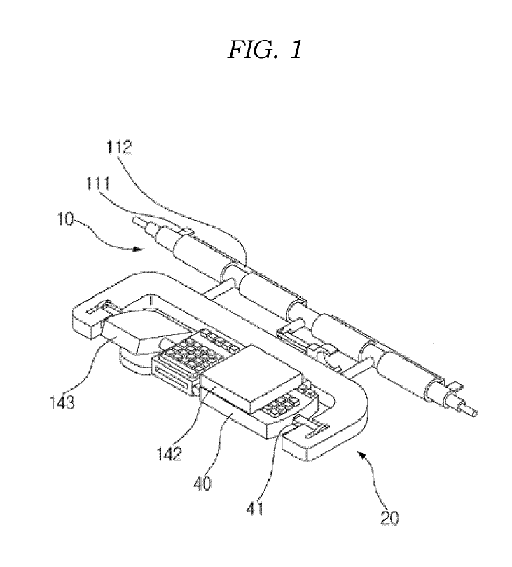

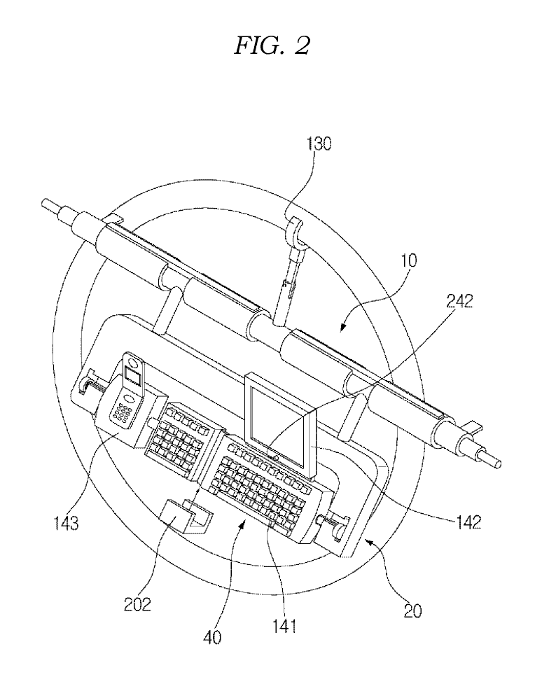

FIG. 1 and FIG. 2 show a frame 20 and a connected part 10.

As shown, the frame 20, which is connected to the connected part 10, is equipped with an information treatment equipment 40 such as, for example, a notebook computer or a portable computer with a display 142 such as a monitor and other equipment and with a communication equipment mounting stand 143 on the side portion. At this case, the installation on the frame 20 is carried out by virtue of a shaft 41. The communication equipment mounting stand 143 is provided for mounting a cellular phone on the outside and for mounting on the inside a communication modem card and a wireless LAN card for the wireless function of the information treatment equipment 40, that is, for the Internet wireless LAN function.

FIG. 2 shows the frame 20 fixed on a steering wheel by using an insertion bar 130 that is foldable. In this case, the device and parts that have not described in the detailed description of the present invention are well disclosed in the prior arts filed by the same applicant as in this invention, and therefore, an explanation of them will be excluded.

As shown, the information treatment equipment 40 includes a display part 142 and a keyboard part 141, and the display part 142 is provided with a camera part 242 on a predetermined position thereon, with which image chatting can be carried out. And the communication equipment mounting stand 143 holds the cellular phone.

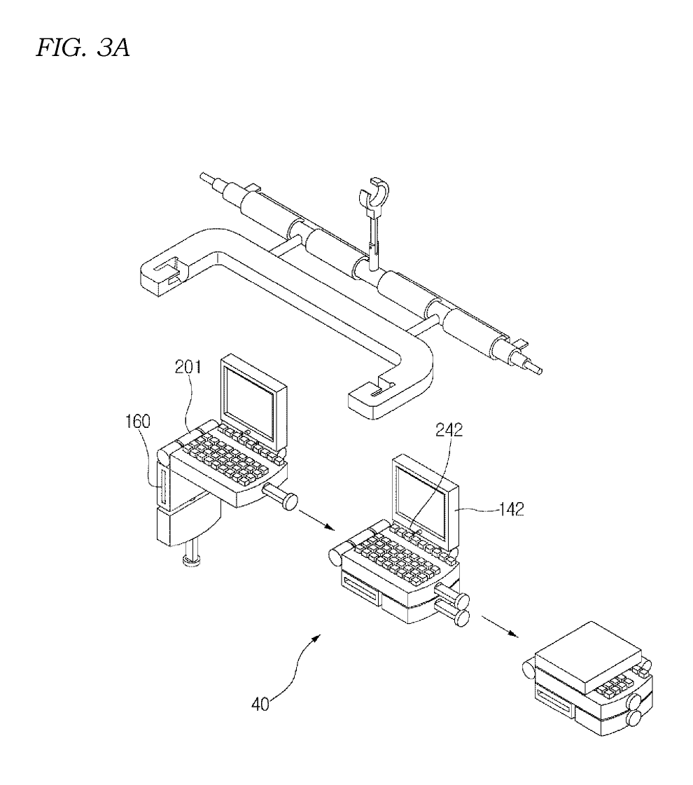

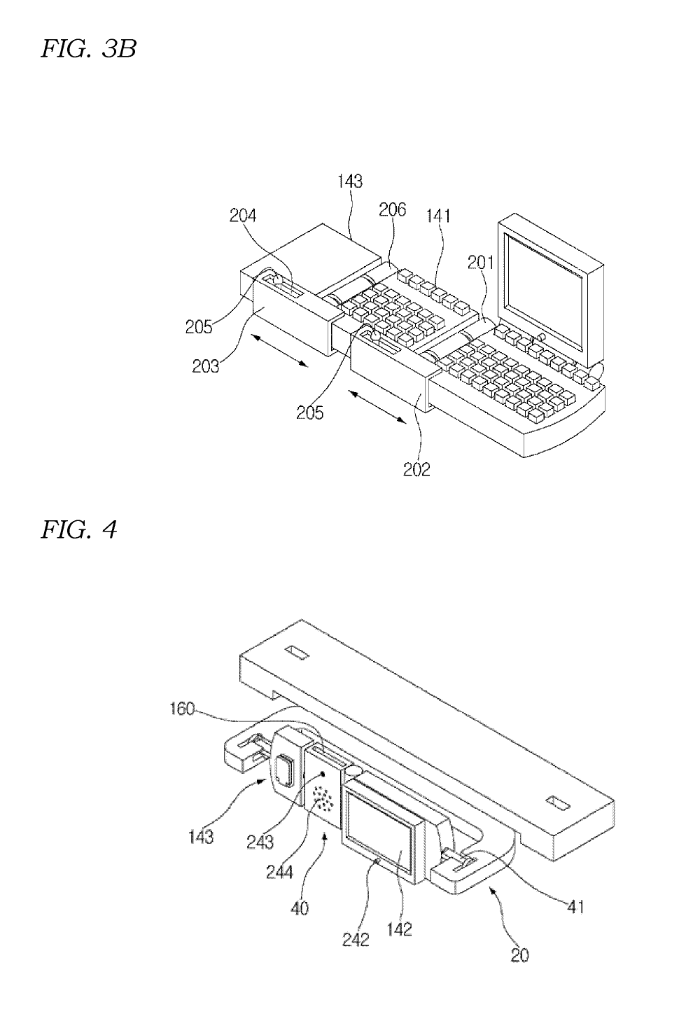

FIG. 3a shows the example where only the information treatment equipment 40 is separated and folded.

As shown, the information treatment equipment 40, which is in the unfolded state as shown in FIG. 2, can be folded for the convenience in use. This is reduced in size to half by means of a hinge part 201 and after that, when the display part 142 is folded, this can be reduced in a compact size as shown in the right side in FIG. 3a. In order to prevent the folded part from being falling down at the time when the hinge part 201 is unfolded, there is provided a separate grip 202 that is fixed on the both ends of the folded part, as shown in FIG. 2.

In addition, the keyboard part on the folded part where the information treatment equipment 40 is reduced in size to half is provided with a card insertion hole 160 through which a card is inserted to conduct accounts on Internet.

FIG. 3b shows another embodiment of the grip 202 in FIG. 2.

In this embodiment, there is provided a second hinge part 206 between the communication equipment mounting stand 143 and the keyboard part 141, and a grip 203 is provided with a relatively long groove 204. On the upper or lower portion of the communication equipment mounting stand 143 or the keyboard part 141, there is provided a guide 205 that guides the grip 203 along the long groove 204. If the guide 205 was disposed on the lower portion of the grip 203 unlike the drawing, the long groove 204 would be formed on the bottom portion of the grip 203.

Under the above construction, the information treatment equipment 40, the communication equipment mounting stand 143 and the keyboard part 141 can be all used, without any separation or falling down.

As shown in FIG. 4, the connected part 10 and the frame 20, as exploded in FIG. 1, are such that a user can carry out image communication in a driver's seat.

At that time, the frame 20 is disposed at such an angle that is appropriate for the image communication. As shown, in other words, the frame 20 stands vertically, and the keyboard part 141 as shown in FIG. 2 is rotated back around the shift 41. Next, the display part 142 is fully folded back. The result is shown in FIG. 4. At this state, the card insertion hole 160 is disposed upward, and the bottom surface thereof is toward the front side. The card insertion hole 160 is provided with a mike 243 and a speaker 244 on the bottom surface.

Thereby, the user can communicate with the person on the display part, while sitting on the driver's seat.

At that time, the communication equipment mounting stand 143 and the information treatment equipment 40 are electrically connected to each other. For example, the call incoming by a cellular phone can be processed to the image communication by the communication equipment mounting stand 143 and the mike 243, the speaker 244, the display part 142, and the camera 242 respectively connected electrically to the communication equipment mounting stand 143.

In other words, all sources (signals and data) of communication (transmission and reception) of the communication equipment mounting stand 143, the inside part thereof, the outside cellular phone, and the inside communication module are used by the above-mentioned parts that are electrically and communicatively connected thereto.

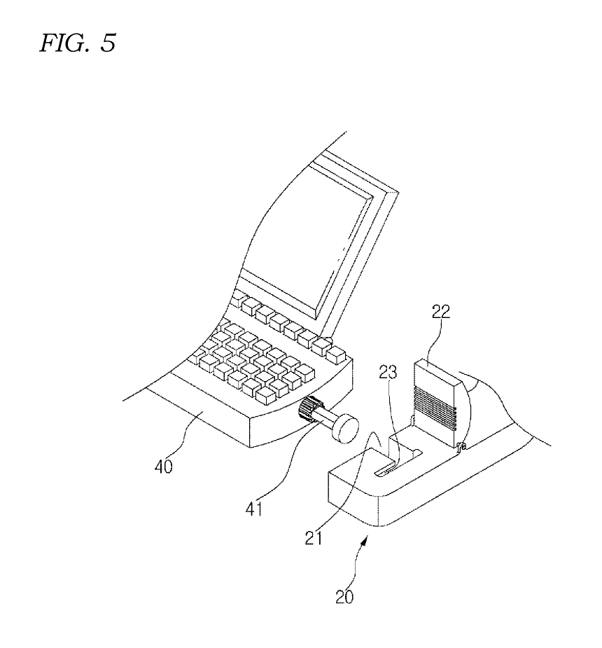

FIG. 5 shows the structure of the shaft 41 coupled to the frame 20.

The frame 20 is provided with a groove 21 into which the shaft 41 is inserted. The groove 21 is extended to a generally long groove 23. Of course, it is possible that there is no need for the formation of the long groove 23.

That is, the shaft 41, which is formed on the side of the information treatment equipment 40 on which various equipments are mounted, is inserted into the groove 21. The groove 21 formed on the frame 20 is provided with a flap 22 that covers the groove 21 after insertion of the shaft 41, on the top portion. The shaft 41 inserted into the groove 21 is further pushed into the long groove 23 such that the shaft 41 and the information treatment equipment 40 are firmly fixed without further development of rotation. Desirably, the long groove 23 becomes narrow in depth, as it gets deeper. This enables the shaft 41 to be rigidly fixed. The shaft 41 is fixed as a unitary body with the information treatment equipment 40 and moved together therewith.

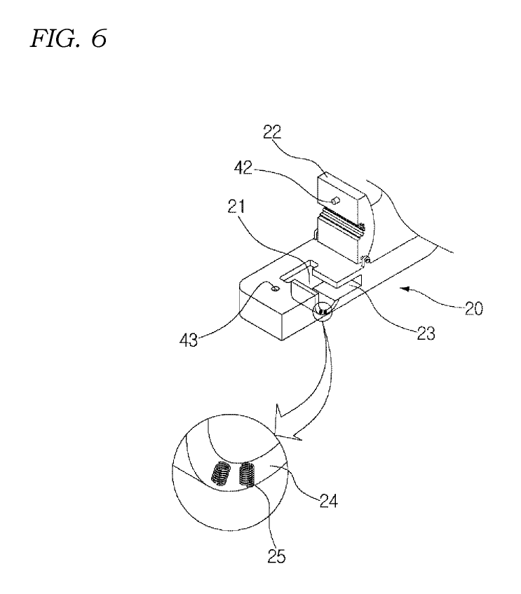

FIG. 6 shows another embodiment of the structure of the shaft 41 in FIG. 5.

In this embodiment, the groove 21 includes an elastic part 24 with elasticity or with one or more springs 25 therein. This allows the installation of the shaft 41 to be made with ease as well as protects the information treatment equipment 40 from impacts or shaking.

Also, the flap 22 is provided with a protrusion 42, and the frame 20 is provided with a groove 43 on the corresponding position to the protrusion 42. If the flap 22 is covered on the frame 20, the protrusion 41 is fitted to the groove 43 such that the flap 22 can be fixed on the frame 20.

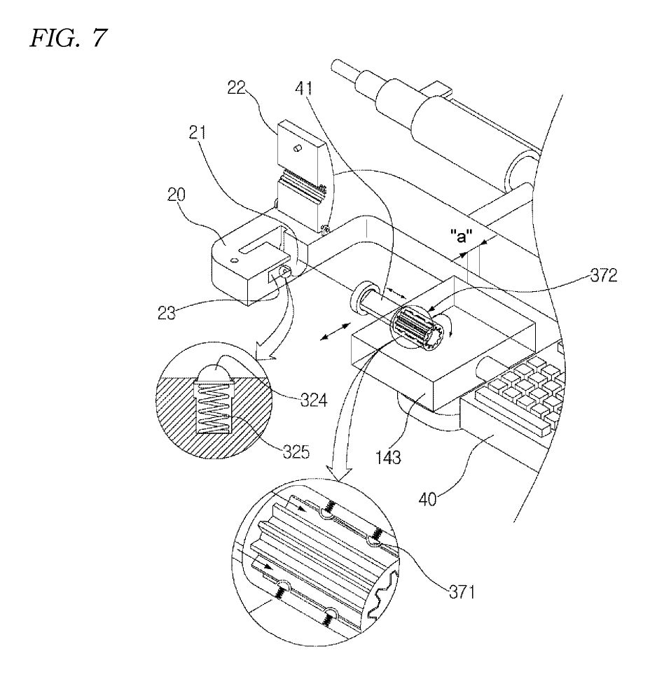

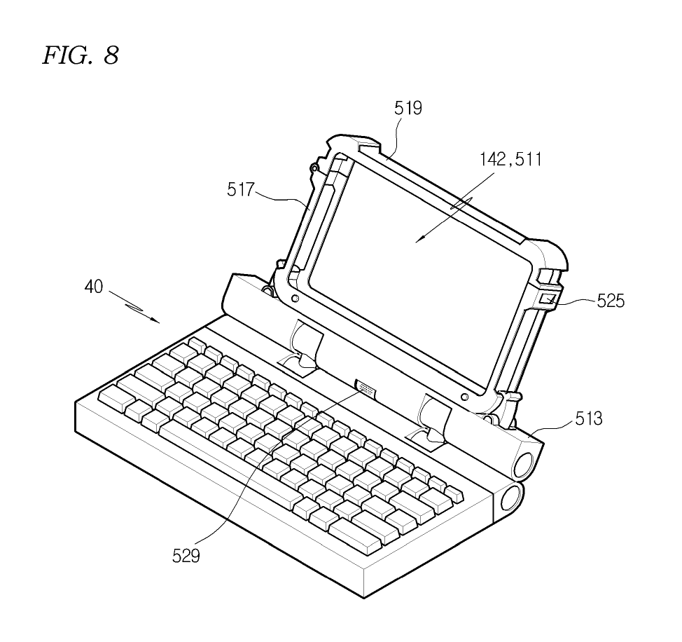

FIG. 7 shows still another embodiment of the structure of the shaft 41 in FIGS. 5 and 6.

In this embodiment, the long groove 23 is formed downward unlike the embodiment of FIG. 6.

The long groove 23 is provided with a projection 324 and a spring 325 on the beginning portion. The shaft 41 is not of a cylindrical shape but a bar shape that is cut on the one parts, as shown. The shaft 41 on each of the sides of the communication equipment mounting stand 143 and the information treatment equipment 40 is connected with a casing 372 that is provided with an elastic body 371 like the assembly of the projection 324 and the spring 325 in the inner diameter. The shaft 41 part connected to the casing 372 takes a similar shape to the shape of the inner diameter of the casing 372 with a result that the shaft 41 can push or pull to/from the casing 372. In this case, the elastic body 371 serves to guide the movement of the shaft 41 in the length direction as well as control the rotation around the shaft 41 by predetermined angles in steps. In this case, two elastic bodies 371 are disposed to face with each other on the front and back portions in a circumferential direction such that four or more or four or less elastic bodies 371 can be formed.

Thereby, the vibration and shaking which may be transmitted by the shaft 41 can be desirably prevented.

In operation, the communication equipment mounting stand 143 and the information treatment equipment 40 that are mounted on the frame 20 cannot rotate in the state where the shaft 41 is inserted into the groove 21. The reason is that the interval (which is shown as ‘a’ in FIG. 7) between the upper portion of the frame 20 and the stand 143 and the information treatment equipment 40 is extremely small such that the stand 143 and the information treatment equipment 40 bump into the upper portion of the frame 20.

If the shaft 41 pulls downward, it presses the projection 324 on the side of the groove 21 and entered the inside of the long groove 23. Thereby, the interval ‘a’ becomes large with a result that the stand 143 and the information treatment equipment 40 rotate to a desired angle convenient to use around the shaft 41. On the other hand, the shaft 41 takes a flat shape with the upper side slightly inclined, and even if the shaft 41 is inserted into the long groove 23, it cannot rotate. That is, the shaft 41 rotates only when the shaft 41 with the inclined upper side should stand vertically, which needs to forcibly press the shaft 41 over the height of the long groove 23. By these reasons, the shaft 41 cannot rotate in the long groove 23.

Therefore, the communication equipment mounting stand 143 and the information treatment equipment 40 that are mounted on the shaft 41 are rotated in the casing 372. In other words, the equipment connected as a unitary body with the casing 273 is rotated around the shaft 41.

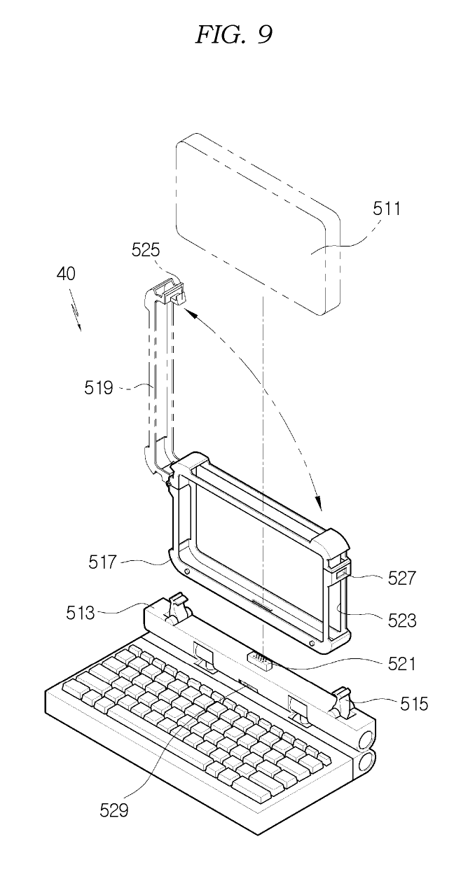

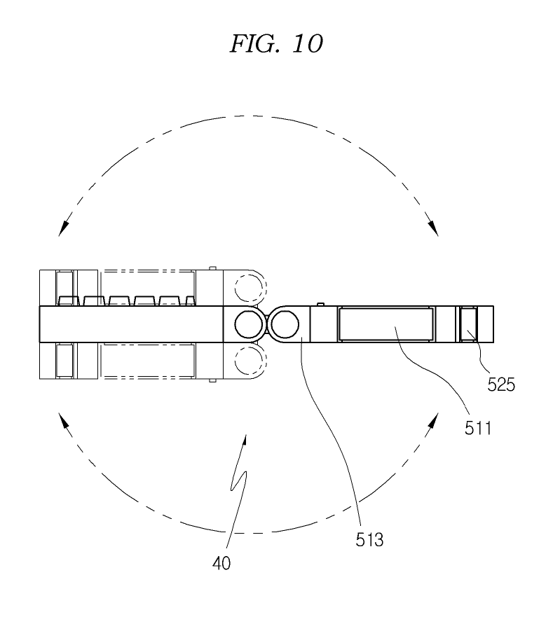

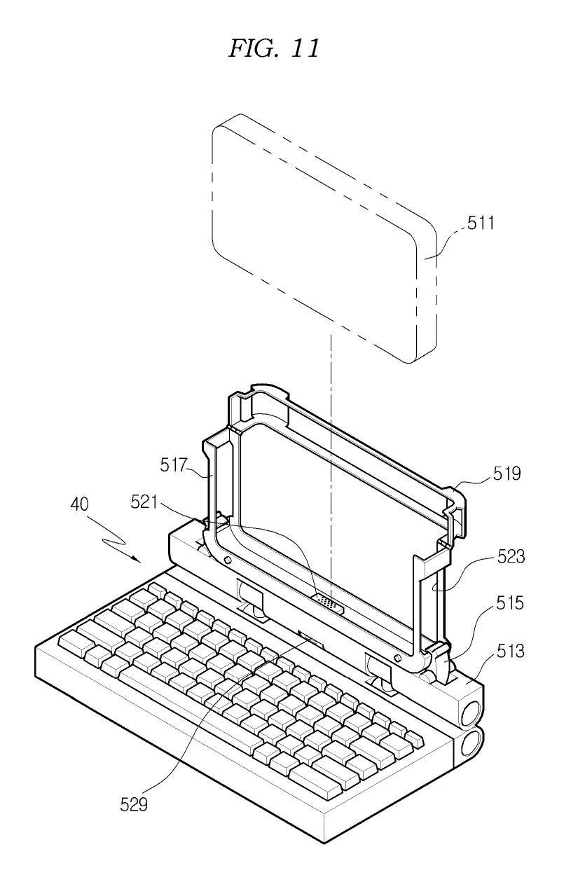

On the other hand, FIGS. 9 to 11 show the information treatment equipment 40 that is provided with the display part 142 to and from which a portable computer (PDA) 511 is attached and detached. The information treatment equipment 40 includes locking bodies 515 that are disposed toward the center on the both sides of a rotary member 513, which rotates by 180.degree. by the application of an external force, a guide frame 517 that is adapted to be locked to the locking bodies 515 and to mount the portable computer 511 into the inside thereof, a support body 519 that is hinge-coupled to the guide frame 517 such that the portable computer 511 mounted in the guide frame 517 is not deviated to the outside of the guide frame 517, and a terminal part 521 that is disposed on the rotary member 513 for electrically connecting to the portable computer 511 and the information treatment equipment 40 for the bi-directional communication therebetween.

The guide frame 517 forms an opened part 523 on the sides thereof, respectively and a locking groove 527 into which a locking protrusion 525 of the support body 519 is locked, on the one side thereof.

On the other hand, the terminal part 521 of the rotary member 513 is provided with a charging terminal 529 for electrically charging the information treatment equipment 40, on the one side thereof.

Under the above-mentioned state, the guide frame 517 is disposed on the top side of the rotary member 513 and is fixed by means of the locking bodies 515. Then, the portable computer 511 is inserted into the guide frame 517 and at the same time, the support body 519 rotates such that the locking protrusion 511 is locked to the locking groove 527. In this state, the portable computer 511 is not deviated from the guide frame 517 and in order for the user's view to correspond with the position of the portable computer 511 set, the guide frame 517 or the rotary member 513 rotates at an appropriate angle. Also, in order to manipulate the portable computer 511 during the operation thereof, manipulating buttons that are not shown in the drawings are pressed through the opened parts 523 on the guide frame 517.

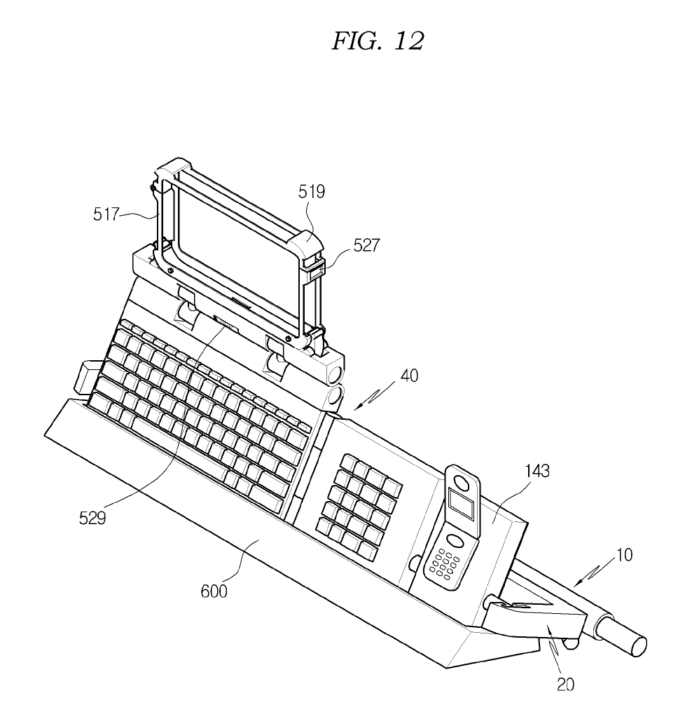

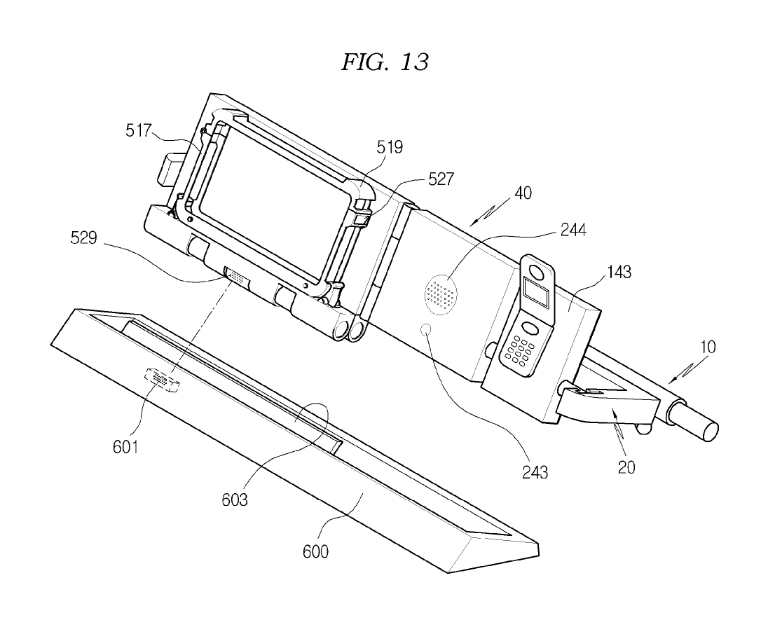

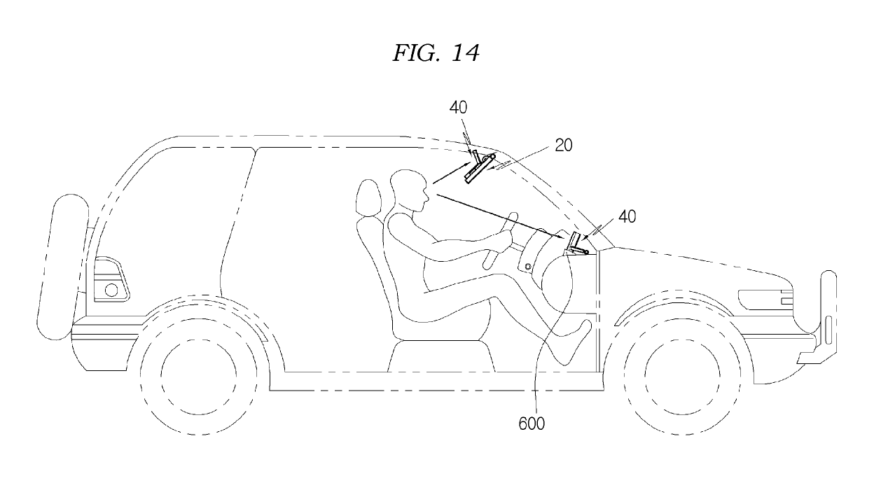

FIGS. 12 to 14 show the information treatment equipment 40 and a mounting stand 600. The mounting stand 600 is fixedly disposed on the front panel of the car, on which the information treatment equipment 40 is placed (in this case, the frame 20 is disposed on the connected part 10 in such a manner as to rotate around the connected part 10). When the information treatment equipment 40 is not in use, the mounting stand 600 charges the information treatment equipment 40 by virtue of charging terminals 601 and 529. The mounting stand 600 forms a compressing and coupling member 603 that is movable on the inside of the center thereof for elastically supporting the information treatment equipment 40 in accordance with the variation of the thickness of the information treatment equipment 40. The information treatment equipment 40 forms the mike 243 and the speaker 244 on the rear portion thereof, for the hands-free function for a cellular phone.

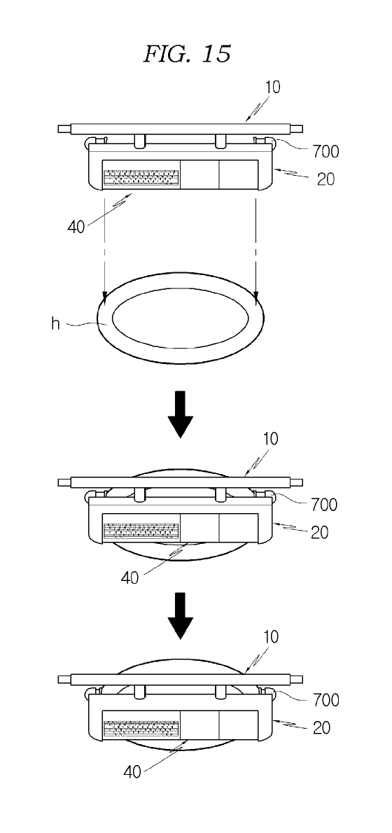

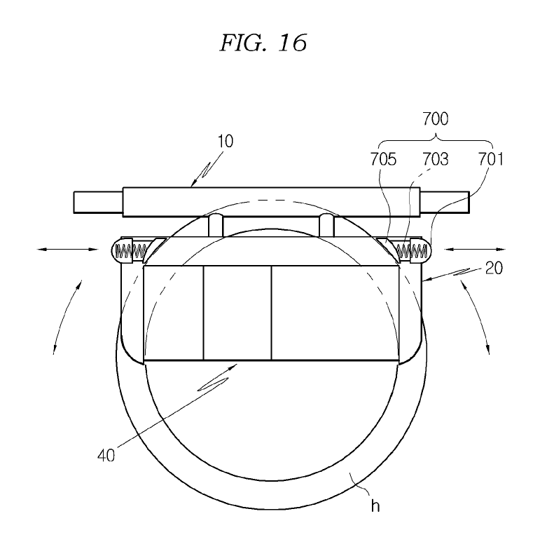

FIGS. 15 and 16 shows the frame 20 mounted in the office work apparatus according to the present invention. While the frame 20 is fixed on the steering wheel h by using the insertion bar 130 as shown in FIG. 2, it is fixed on the steering wheel h by using a compressing and supporting part 700 as shown in FIGS. 15 and 16. The compressing and supporting part 700 includes a guide groove 701 that is formed on a predetermined portion of the frame 20, a spring 703 that is disposed on the guide groove 701 to generate pressure to the outside, and a support body 705 that is formed on the front end of the spring 703 and comes in contact with the curved face of the steering wheel h. The support body 705 is formed along the curved face of the steering wheel h such that the frame 20 is stably fixed on the steering wheel h. In case of separating the steering wheel h from the frame 20, the support body 705 pulls to the outside of the steering wheel h, and also the frame 20 is disposed in the upward direction thereof.

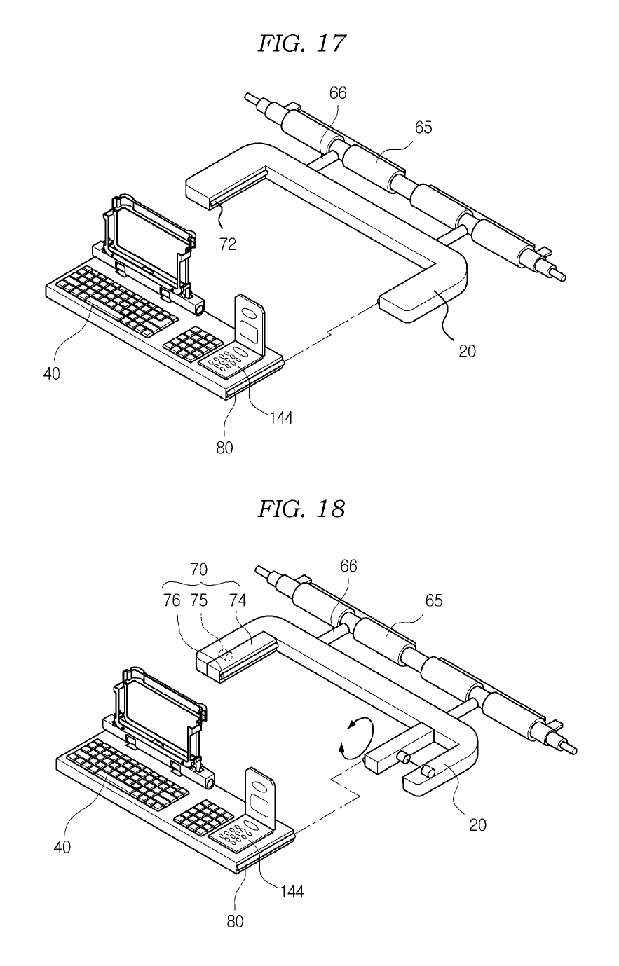

In accordance with another embodiment of the present invention, the frame body 20 includes holding members 70 at both sides thereof and the information treatment equipment 40 includes guiding grooves 80 which engages with the holding members 70, as shown in FIGS. 17 to 21, respectively. The holding members 70 may be formed as guide rails 72 provided on inner surfaces of both sides of the frame body 20, as shown in FIG. 17. Alternatively, the holding members 70 may be formed as separated members each of which has a guide rail 76 and is rotatably engaged with the frame body 20, as shown in FIG. 18.

In FIG. 17, the information treatment equipment 40 is slidably engaged with the holding members 70, i.e., the guide rails 72, of the frame body by inserting the guide rails 72 into the guide grooves 80. Either the guide rails 72 or the guide grooves 80 is configured to offer increased friction forces at the end portion thereof, thereby preventing unintended separation of the information treatment equipment 40 from the frame body 20.

In FIG. 18, each of the holding members 70 includes a pin which formed on one side thereof and is inserted into a hole provided on the inner surface of the frame body, and a guide rail 76 which formed on the opposite side and engages with the guide groove 80. The information treatment equipment 40 engages with the frame body 20 in a similar manner as in the embodiment of FIG. 17. In such a configuration, the information treatment equipment 40 and the holding members 70 can rotate with respect to the frame body 20.

In a modified embodiment, the guide rails 72 or 76 may formed on the information treatment equipment 40 and the guide grooves 80 may be provided on the frame body 20.

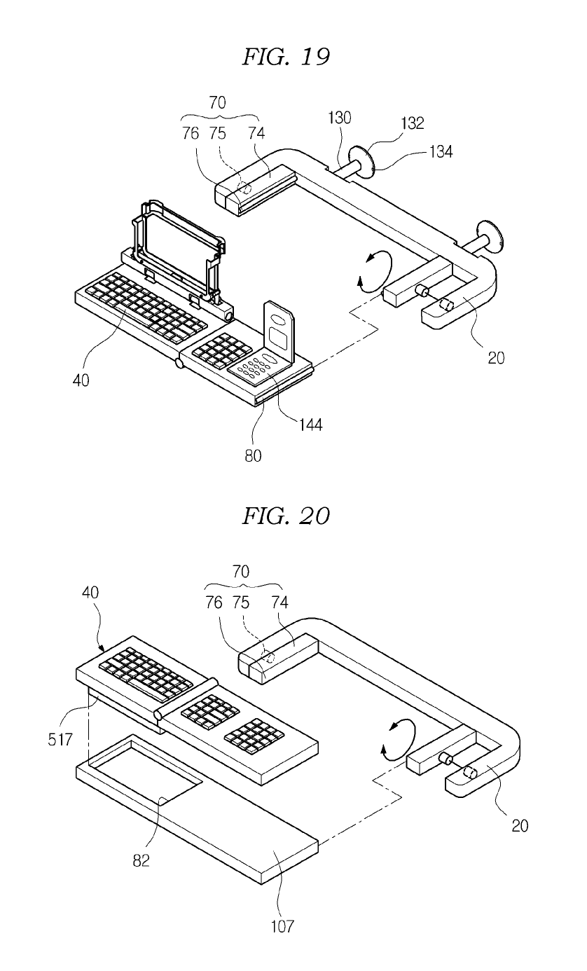

In accordance with another embodiment of the present invention, the frame body 20 may be undetachably fixed to the ceiling of a vehicle, as shown in FIG. 19. In such an embodiment, the frame body 20 includes shaft 130 whose end portion 132 is fixed to the ceiling of a vehicle by, for example, screws 134.

In another embodiment of the present invention, a carrying member 180 for mounting the information treatment equipment 40 thereon can be provided, as shown in FIG. 20. The carrying member 180 may have an opening 182 into which the display 517 of the information treatment equipment 40 is inserted.

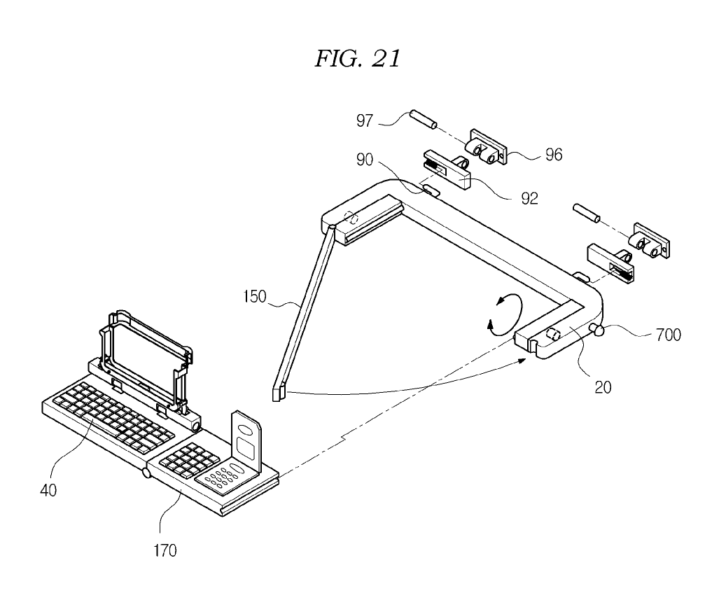

As shown in FIG. 21, the frame body 20 may include a locking member 130. One end portion of the locking member 130 is hinged to the frame body 20 and the other end portion of the locking member 130 engages with the frame body 20. In such a configuration, unintended separation of the information treatment equipment 40 from the frame body 20 can be prevented by closing the locking member 130. Further, the locking member 150 may include protruded portion 160 to support the information treatment equipment 40. An insertion groove 170 may be provided on the side portion of the information treatment equipment 40 to receive the protruded portion 160.

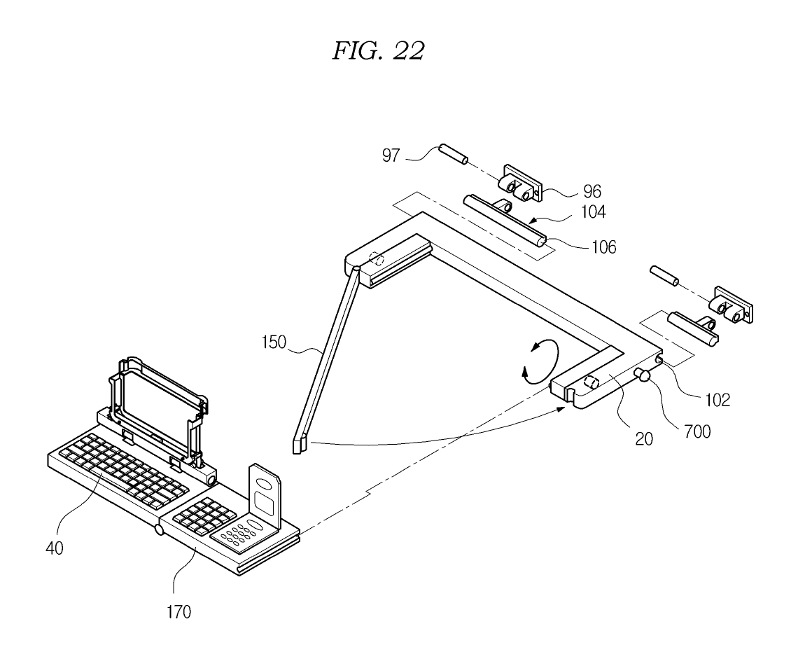

In FIG. 22, the frame body includes sliding grooves 102 which formed in a longitudinal direction of the frame body 20. Connecting members 106 are slidably engaged with the sliding grooves 102. Preferably, at least two (2) connecting members are provided.

The connecting member 102 is rotatably engaged with ceiling-connected parts 96 via a pin 97.

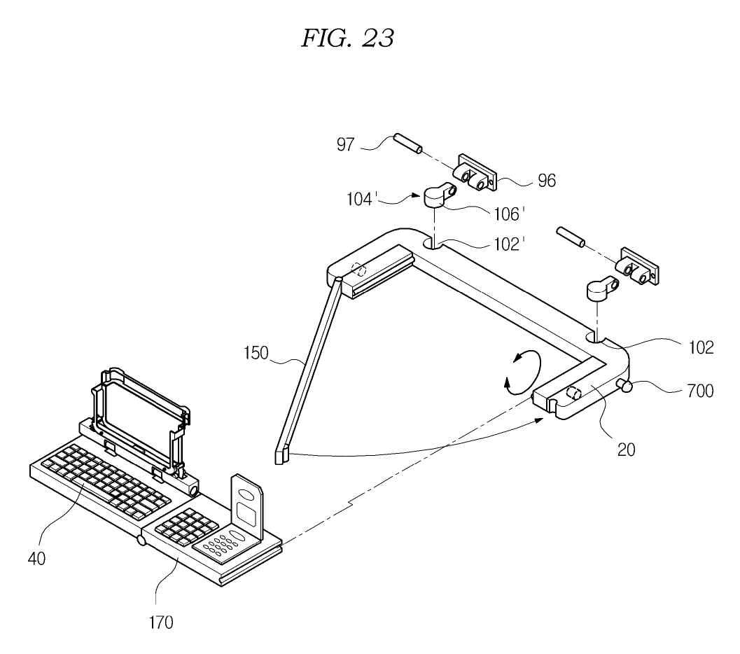

In FIG. 23, there shows another type of connecting members 106′ which slidable engaged with sliding grooves 102′ formed in a traverse direction of the frame body 20. It is preferable that end portion of each connecting member 106′ has a cross shape to secure firm engagement.

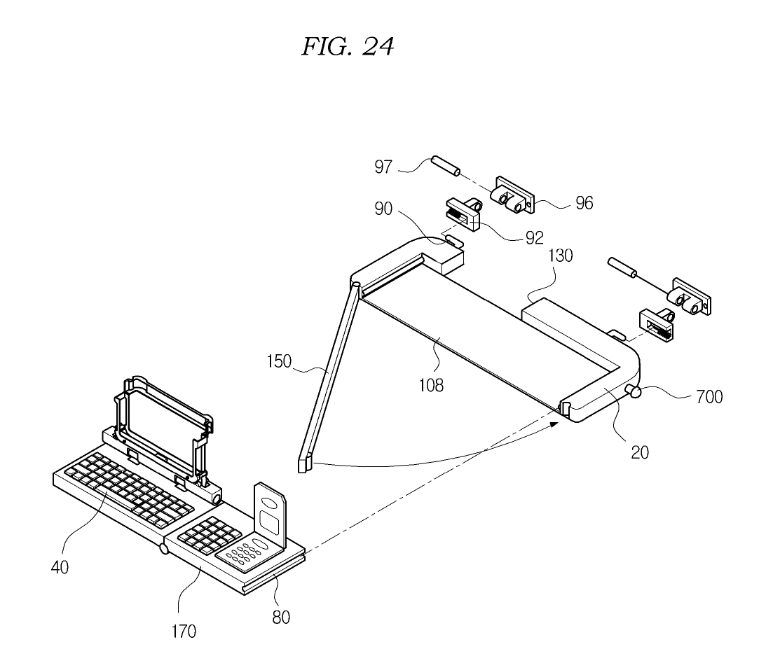

In the embodiment shown in FIG. 24, the frame body 20 includes a base plate 107 for supporting the information treatment equipment 40. The base plate 107 also prevents the information treatment equipment 40 to be harmed by external forces. Further, a portion of the frame body 20 may be canceled so that the movement of the display does not interfere with the frame body 20.

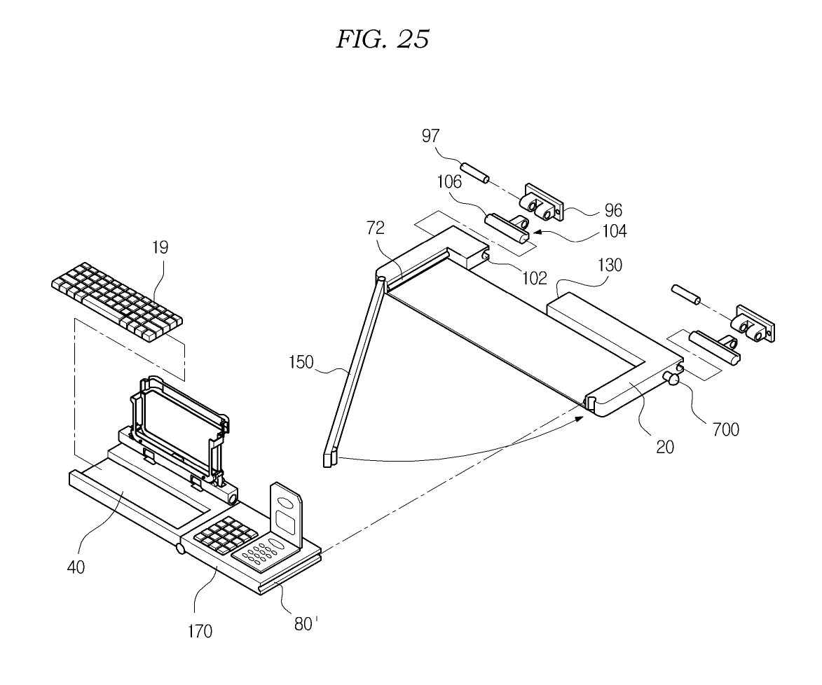

As shown in FIG. 25, the carrying member 180 may include a keyboard slot 140 into which keyboard is inserted.

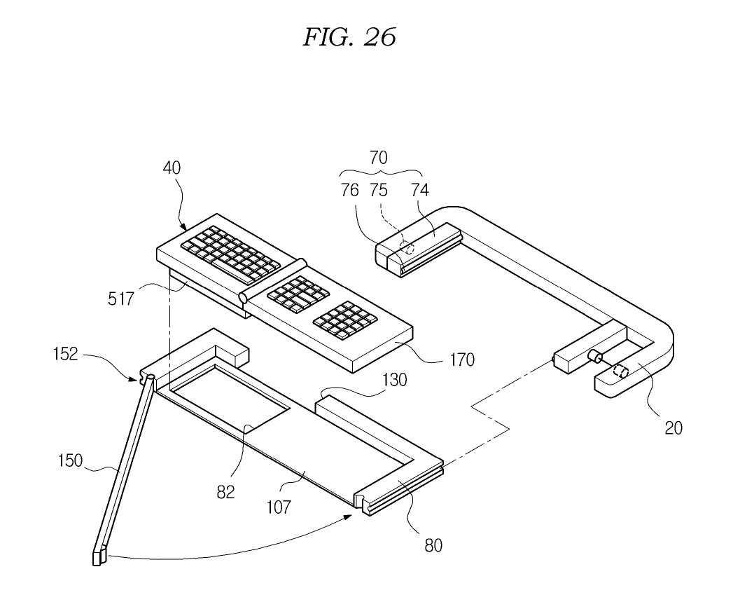

In FIG. 26, there shows another type of the carrying member 180. Such carrying member 180 includes a frame portion having a base plate 107, an opening for receiving the display 182, and a locking member 150. One end portion of the locking member 150 is hinged to the frame portion and the other end portion of the locking member 150 engages with the frame portion. A portion of the frame portion is canceled so that the movement of the display may not interfere with the frame portion.

### INDUSTRIAL APPLICABILITY

As set forth in the foregoing, with the office work apparatus according to the present invention, a user can access Internet and handle his or her business in a driver's seat.

Also, the office work apparatus according to the present invention is placed on the steering wheel for handling the user's work, the office work apparatus with the keyboard is safely mounted on the groove with a buffer spring, such that the office work apparatus can be protected from the impacts applied from the outside, without any shaking.

In addition, a portable computer (PDA) is installed in an attachable and detachable manner in the display part of the office work apparatus, thereby enabling the installation of the portable computer to be easily achieved, and the portable computer is mounted by a guide frame and a support body and rotates by means of a rotary member, thereby enabling the operation thereof to be achieved in any position.

While the present invention has been shown and described with respect to the preferred embodiments, it will be understood by those skilled in the art that various changes and modifications may be made without departing from the spirit and scope of the invention as defined in the following claims.

What is claimed is:

1. An office work apparatus for cars comprising, an information treatment equipment includes a keyboard and a display, a frame to which the information treatment equipment is detachably mounted, and an on-wheel mounting member for detachably installing the information treatment equipment on a steering wheel of a vehicle.

2. The office work apparatus for cars of claim 1, wherein the information treatment equipment is foldable.

3. The office work apparatus for cars of claim 1, wherein the information treatment equipment is rotatably mounted on the frame.

4. The office work apparatus for cars of claim 1, wherein a portable computer is detachably mounted to the information treatment equipment.

5. The office work apparatus for cars of claim 4, wherein the information treatment equipment includes a portable computer carrying frame for receiving the portable computer, a frame engaging part for fixing the portable computer carrying frame to the information treatment equipment, the portable computer carrying frame having a door part which is hinged to the portable computer carrying frame and prevent unintended separation of the portable computer from the portable computer carrying frame.

6. The office work apparatus for cars of claim 5, wherein the portable computer carrying frame has a side opening for permitting access to operation switches of the portable computer.

7. The office work apparatus for cars of claim 1, further comprising a mounting stand which installed on the front dash panel of a vehicle for supporting the information treatment equipment.

8. The office work apparatus for cars of claim 1, wherein the on-wheel mounting member includes a pair of supporting members provided at both side portions of the information treatment equipment, each supporting member having a head portion which contacts with the steering wheel, a resilient member for providing a resilient force against the head, and a receiving grove for accommodating the resilient member.

9. The office work apparatus for cars of claim 1, wherein the information treatment equipment includes guide grooves at both side portions thereof and the frame includes holding members at both side portions thereof for engaging with the guide grooves.

10. The office work apparatus for cars of claim 9, wherein the holding member is a guide rail formed on the frame.

11. The office work apparatus for cars of claim 9, wherein the holding member is a separate member which rotatably engages with the frame and has a guide rail engaging with the guide groove of the information treatment equipment.

12. The office work apparatus for cars of claim 1, wherein the frame includes a locking member for preventing unintended separation of the information treatment equipment from the frame.

13. The office work apparatus for cars of claim 1, wherein the frame includes a base plate for supporting a bottom surface of the information treatment equipment.

14. The office work apparatus for cars of claim 1, further comprising a base plate for supporting a bottom surface of the information treatment equipment, a carrying member which includes guide grooves at both side portions thereof, and a guide rail formed on the frame which engages with the guide grooves.

15. The office work apparatus for cars of claim 14, wherein the carrying member further comprises a locking member for preventing unintended separation of the information treatment equipment from the frame.
